(19) United States
(12) Patent Application Publication
(10) Pub. No.: US 2006/0055132 A1
(43) Pub. Date: Mar. 16, 2006

(54) Industrial truck having a fork damper

(76) Inventor: Michael Schonauer, Moosburg (DE)

Correspondence Address: EDWARDS & ANGELL, LLP, P.O. BOX 55874, BOSTON, MA, 02205, US

(21) Appl. No.: 11/203,555

(22) Filed: Aug. 12, 2005

(30) Foreign Application Priority Data
Aug. 20, 2004 (DE) 10 2004 040 529.8

(51) Int. Cl. B60N 2/427

(52) U.S. Cl. 280/29

(57) ABSTRACT

An industrial truck having at least one elongate load-accommodating means (10) and a bearing structure (16) supporting the load-accommodating means (10), the load-accommodating means (10) being connected to the bearing structure (16) and it being possible for said load-accommodating means (10) to be pivoted about a pivot axis (SA) in relation to the bearing structure (16) between a use position and a non-use position, and the load-accommodating means (10) being supported on the bearing structure (16) in the use position, is characterized in that a damping arrangement is provided on the load-accommodating means (10) and/or on the bearing structure (16) and has at least one elastic damper element.

### DESCRIPTION

The present invention relates to an industrial truck having at least one elongate load-accommodating means and a bearing structure supporting the load-accommodating means, the load-accommodating means being connected to the bearing structure and it being possible for said load-accommodating means to be pivoted about a pivot axis in relation to the bearing structure between a use position and a non-use position, the load-accommodating means being supported on the bearing structure in the use position.

In such industrial trucks, the pivot axis is generally arranged in relation to the at least one load-accommodating means such that the load-accommodating means is held in a use position owing to its intrinsic weight. In this case, the pivot axis of the load-accommodating means is arranged offset from its longitudinal centre, with the result that a front part of the load-accommodating means, which is in front of the pivot axis, is longer than a rear part which is supported on the bearing structure of the industrial truck. Owing to the longer front part, a bearing moment is produced about the pivot axis such that the rear part of the load-accommodating means can be supported on a support on the bearing structure, and the load-accommodating means is held in this position.

Since the load-accommodating means is only supported on the bearing structure, it can be deflected for a short period of time out of the supported use position, for example when the industrial truck traverses uneven sections of ground. After this deflection, the load-accommodating means moves back into the use position owing to the above-described bearing moment, the rear part of the load-accommodating means hitting the support of the bearing structure. On the one hand, this produces noise and, on the other hand, the impact or impacts is/are transmitted to the bearing structure, which may impair the robustness of the bearing structure over a longer period of time and in the case of repeated impacts.

It is therefore the object of the present invention to weaken the noise produced and the impact caused when the load-accommodating means hits the bearing structure of the industrial truck.

In accordance with the invention, the object is achieved by a generic industrial truck in which a damping arrangement is provided on the load-accommodating means and/or on the bearing structure and has at least one elastic damper element. Owing to the elasticity of the damper element, said damper element is deformed when the load-accommodating means hits, as a result of which said load-accommodating means is braked over a short period of time, but not suddenly. This leads to lower force peaks in the bearing structure and also to a softer impact with reduced production of noise.

In principle, it is possible for such a damping arrangement to be formed only by one or more elastic damper elements. The damping arrangement preferably comprises at least one substantially rigid element, preferably a steel element, to which the damper element is fixedly connected, for example by means of adhesive bonding or vulcanization, and which can be arranged or is arranged on the bearing structure and/or the load-accommodating means. The rigid element, which may also be referred to as the support element of the damper element, has greater deformation rigidity than that of the damper element such that, when the load-accommodating means hits the damping arrangement, the rigid element is deformed to a negligible degree in comparison with the elastic damper element.

In order to be able to match the damping arrangement optimally to a desired distance between the load-accommodating means and the bearing structure, the damping arrangement preferably comprises at least one spacer element which can be arranged or is arranged between the damper element and the base bearing said damper element, preferably between the rigid element and the base bearing the damping arrangement. In this case, it is conceivable for it to be possible for the spacer elements to be used advantageously in particular when retrofitting an industrial truck with a damping arrangement according to the invention if, for example, the elastic damper element is possibly provided with the rigid support element as a standard component.

In order to fix the damping arrangement to the load-accommodating means and/or the bearing structure, the damping arrangement may have at least one fixing geometry. For example, it may be possible for the damping arrangement to be pushed or snapped into a corresponding holder on the base with its side edges.

The at least one fixing arrangement may extend, as a cutout for example in the form of a U, from a side edge of the damping arrangement to the interior thereof, which makes it possible for the damping arrangement to be inserted and fitted to corresponding shaped parts which are arranged on the bearing structure and/or on the load-accommodating means through the lateral opening of the cutout. A screw holding the damping arrangement in this case only needs to be slightly unscrewed. The cutout may surround, at least in sections, a screw shaft in the mounted state of the damping arrangement, with the result that the damping arrangement can be held on the base securely by means of the clamping force of a screw.

The fixing geometry is preferably an aperture through which a fixing means, for example a screw, can pass, with the result that the damping arrangement can be fixed to the base bearing it in an undetachable manner. The aperture may be, for example, a slot. Such a design has the advantage that the damping arrangement can be displaced on the base with respect to the longitudinal axis of the slot over a certain dimension, in relation to corresponding fixing points.

In a particularly preferred embodiment, the fixing geometry is a drilled hole which extends through the damping arrangement. This makes it possible for the damping arrangement to be attached at a defined point with respect to the cutout or the slot.

The fixing cutout may comprise at least two successive cutout sections in the direction towards a base bearing the damping arrangement, of which the cutout section which is further away from the base has a greater clear width than that of the cutout section which is nearer to the base. In this case, the clear width represents the distance between two opposing walls which delimit the cutout section, the clear width, for example in the case of a drilled hole, corresponding to the diameter of this drilled hole.

A locating section of a fixing means, for example the head of a screw, may be accommodated in the cutout section which is further away from the base, with the result that the locating section, in the mounted state of the damping arrangement, reliably lies closer to the base than a bearing face of the damper element, on which the load-accommodating means or the bearing structure rests during operation. The locating section can then exert a holding force on the cutout section which is nearer to the base and thus hold the damping arrangement on the base in a force-fitting or even an interlocking manner.

The cutout section referred to which is nearer to the base and the cutout section referred to which is further away from the base preferably lie in the rigid support element, since said support element is better suited than the damper element for absorbing fixing forces owing to its rigidity. However, this should not rule out the possibility of at least the cutout section which is further away from the base being capable of extending into the damper element.

The cutout section which is nearer to the base and the cutout section which is further away from the base are particularly preferably formed with the different clear widths referred to, as the depression, such that a screw shaft passes through the cutout section which is nearer to the base, while the cutout section which is further away from the base accommodates a screw head. In this case, a conical depression may further advantageously be provided since this allows for screws with flat heads to be used, with the result that the screw head barely protrudes into the region of the damper element or does not protrude at all into this region when it bears against the conical depression in the support element, with the result that a deformation path which is as large as possible is provided for the damper element for the purpose of accommodating impact forces.

The above-described cutout sections are intended also to cover the case in which exclusively a conical depression, i.e. without a cylindrical section adjoining it, is formed in the support element. In this case, the larger opening of the conical depression is to be understood in the context of the present application to be the cutout section with the greater clear width, and the smaller conical depression opening is to be understood in the context of the present application to be the cutout section with the smaller clear width. In this case, the cutout section which is further away from the base merges in stepless fashion with the cutout section which is nearer to the base and has a smaller clear width.

Express reference is made to the fact that, in addition to the cutout section which is further away from the base and the cutout section which is nearer to the base, which are referred to above, other cutout sections may be provided which may be positioned both even further away from the base and even nearer to the base. When designing the cutout section which is nearer to the base and the cutout section which is further away from the base in the support element, as are described above, a cutout section which is even further away from the base and has a large clear width is generally provided in the damper element such that the locating section of the fixing means used can be pushed through the damper element to the cutout section which is further away from the base referred to above.

In order to make it possible to access the fixing cutouts in the use position of the load-accommodating means, the damping arrangement is preferably fitted to the bearing structure. In order to further improve accessibility of the fixing cutouts, the distance between the closest edges of fixing cutouts is preferably fixed such that it is greater than the width of the load-accommodating means. With such an arrangement, the fixing cutouts are in this case also freely accessible if the load-accommodating means is supported in the use position on the bearing structure. In addition, such an arrangement has the advantage that, in the use position in which the load-accommodating means is normally supported on the bearing structure owing to its intrinsic weight, the fixing means provided in the fixing cutouts, for example screws, can be released, the damping arrangement still being held in its position by the load-accommodating means.

In order to achieve an optimal damping effect, the damper element is produced from plastic, preferably from an elastomer, such as rubber. Depending on the dimensions of the load-accommodating means and the maximum weight of the loads to be conveyed by the industrial truck by means of the load-accommodating means, the material of the damper element may be more or less elastic, i.e. have a higher or lower modulus of elasticity. In this case, in accordance with an advantageous development, it is also conceivable for the damping arrangement to have two or more damper elements having different elastic material properties. When two or more damper elements are arranged one behind the other in the direction of impact, it is thus essentially possible for initially a layer having a lower modulus of elasticity to be deformed in the event of an impact, and to damp the impact. When a maximum load is accommodated on the load-accommodating means, compression of all of the existing damper elements takes place, in this case, for example, a damper element having a higher modulus of elasticity exerting a damping action in the case of an impact since the abovementioned damper element having a lower deformation rigidity can be almost completely compressed under a maximum load.

In accordance with one advantageous development or one further aspect of the invention, it is preferable for a distance between a standing area of the industrial truck and an underside, which faces the standing area, of the load-accommodating means to increase at least in sections towards at least one longitudinal end, preferably towards both longitudinal ends, of the load-accommodating means. The section with the change in distance preferably contains a longitudinal end, particularly preferably both longitudinal ends, of the load-accommodation means.

The increase in the distance between the standing area of the industrial truck and the underside, which faces the standing area, of the load-accommodating means is particularly expedient in a rear region of the load-accommodating means in which the load-accommodating means rests on the bearing structure as has already been described above, since a small deflection of the load-accommodating means can take place when the industrial truck traverses uneven sections of ground. The increase in distance from the standing area prevents the underside of the rear region of the load-accommodating means from hitting the ground when it is deflected out of the use position, with the result that it is possible to prevent both damage to the load-accommodating element and to the ground, or to the standing area. If the distance between the standing area and the front section of the load-accommodating means is increased, a type of wedge forms in the front region of the load-accommodating means, and this wedge makes it easier to insert the load-accommodating means, or the fork of the industrial truck, in corresponding openings in the loads to be transported, for example pallets.

One embodiment of the present invention will be described below with reference to the drawings, in which:

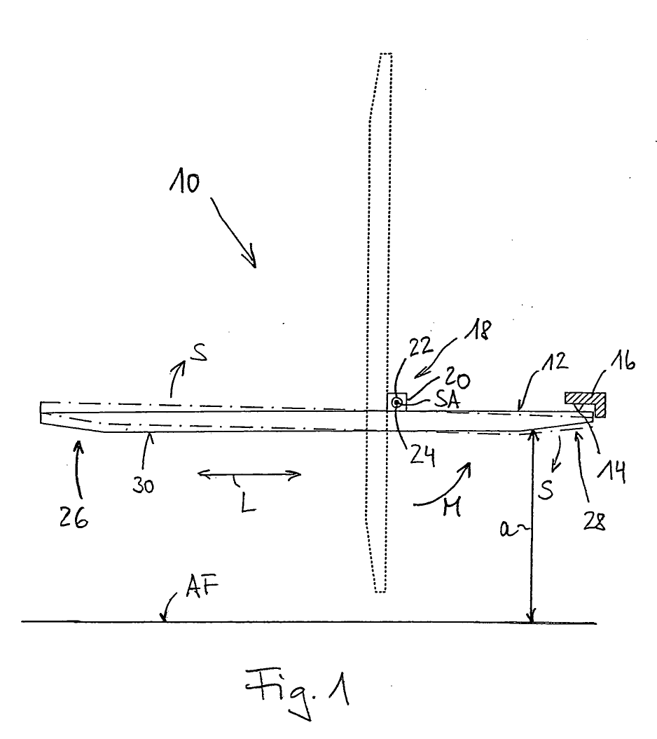

FIG. 1 shows a schematic view of a load-accommodating means in a use position, a short-term deflected position and a non-use position;

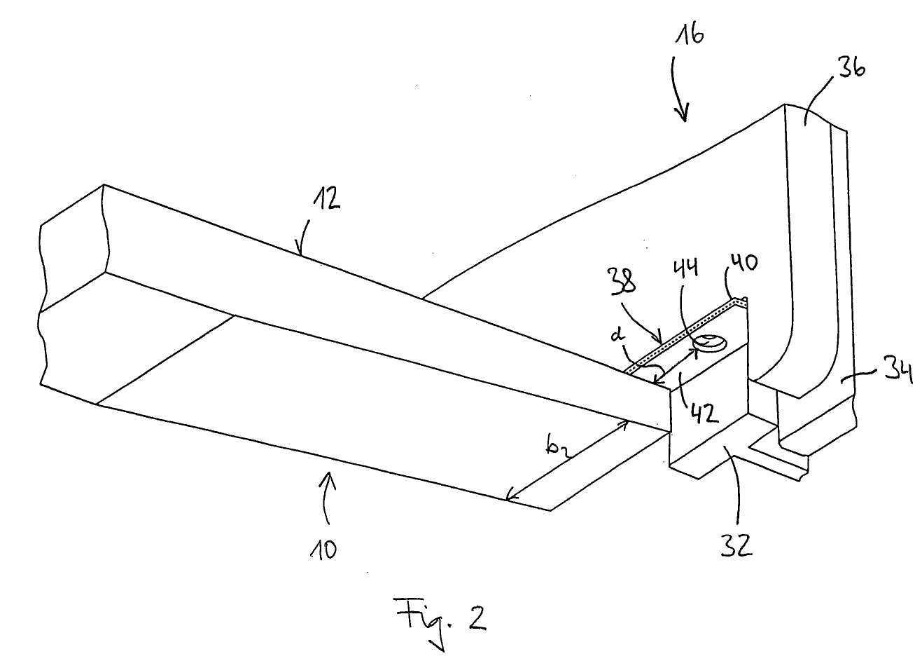

FIG. 2 shows a simplified, perspective illustration of the point at which the load-accommodation means is supported on a bearing structure of an industrial truck; and

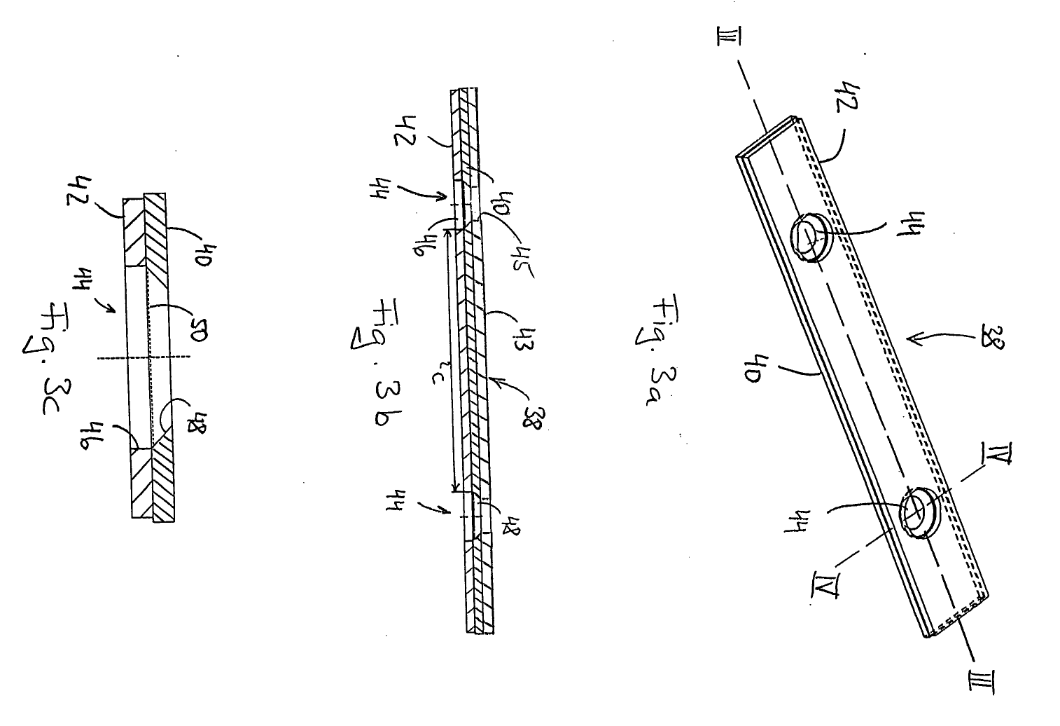

FIGS. 3a-3c show a damping arrangement, FIG. 3b showing a cross section along the line III-III, and FIG. 3c showing a cross section corresponding to the line IV-IV.

A load-accommodating means 10 is illustrated in FIG. 1 in a continuous line in its use position. In the use position, an upper side 12 is supported on a bearing point 14 of a bearing structure 16 indicated merely schematically, the load-accommodating means 10 is pivoted by means of a hinge 18 which can rotate and which comprises, for example, a sleeve 22 arranged on a connecting piece 20 and a hinge pin 24 which lies therein and is fixed to a region (not illustrated in any more detail) of the bearing structure 16. The load-accommodating means 10 can be pivoted about the pivot axis SA which extends through the pin 24 substantially orthogonally with respect to the longitudinal direction L of the load-accommodating means 10 and orthogonally with respect to the plane of the drawing in FIG. 1.

In a non-use position of the load-accommodating means 10, which is illustrated as a dashed line, the load-accommodating means 10 is pivoted such that it is substantially orthogonal with respect to the use position. In this case, account should be taken of the fact that a torque M, which normally causes a pivoting movement of the load-accommodating means 10 into the use position, acts on the basis of the hinge 18 which is arranged eccentrically in relation to the longitudinal axis of the load-accommodating means 10. As a result, the load-accommodating means 10 needs to be secured in the non-use position by means of securing devices (not illustrated).

During use of the industrial truck, the load-accommodating means 10 is moved for a short period of time from the use position into a deflected position (illustrated using dashed-dotted lines), for example when uneven sections of ground are traversed. In this case, the load-accommodating means 10 pivots in the direction of the arrow S, as a result of which a front section 26 of the load-accommodating means is lifted and a rear section 28 of the load-accommodating means 10 is lowered. Since the deflection into the deflected position takes place for only a short period of time owing to the resetting action of the torque M, the load-accommodating means 10 in its rear section 28 hits against the bearing point 14 of the bearing structure 16 with the upper side 12.

It can also be seen in FIG. 1 that a distance a between an underside 30 of the load-accommodating means 10 and the standing area AF of the industrial truck increases towards the respectively associated longitudinal ends both in the front section 26 and in the rear section 28 of the load-accommodating means 10, which is achieved by a wedge-shaped design of the sections 26 and 28.

FIG. 2 is a simplified, perspective illustration of the bearing point 14 illustrated schematically in FIG. 1, the direction of view being selected to be at an angle from below.

The bearing structure 16 in this illustration shows a moving lifting frame 32 which can be moved along a fixed lifting stand 34. A fork carrier 36 which is mounted such that it can be displaced on the moving lifting frame 32 can be displaced along the lifting frame 32 together with the load-accommodating means 10 and a damping arrangement 38 fitted to the fork carrier 36.

The damping arrangement 38 comprises a substantially rigid element or support element 40, which faces the fork carrier 36 and bears against it and to which an elastic damping element 42 is fixedly connected. An end section of the upper side 12 of the load-accommodating means 10 is supported on the elastic damper element 42, which corresponds to the use position described in FIG. 1.

The damping arrangement 40 is fixed to the fork carrier 36 by means of two screw connections, only one opening or drilled hole 44 in a first screw connection being illustrated. If the industrial truck moves over an uneven section of ground, a small distance will be produced for a short period of time between the damper element 42 and the upper side 12 of the load-accommodating means 10 owing to the deflection of the load-accommodating means 10. When the load-accommodating means 10 returns to the use position, the upper side 12 of the load-accommodating element 10 again hits the elastic damper element 42, the damper element 42 damping the impact on the fork carrier 36 and thus on the overall bearing structure 16 and considerably reducing the production of noise.

FIG. 3a shows a damping arrangement 38 having the rigid element or support element 40 and the elastic damper element 42 associated therewith. The elastic damper element 42 may be formed from plastic, for example rubber, polyurethane, plastic based on silicone or the like, the damper element 42 being characterized by a lower modulus of elasticity than the support element 40, for example a modulus of elasticity which is lower by a factor of 15-25, as a result of which substantially the damper element 42 is deformed and the support element 40 is only deformed to a negligible extent when the upper side 12 of the load-accommodating means 10 hits the damping arrangement 38. The distance c between the two drilled holes 44, which is measured between the closest inner edges of the drilled holes 44, is selected such that it is larger than the width b of the load-accommodating means 10. As has already been mentioned and as can be seen with renewed reference to FIG. 2, the drilled holes 44 and thus also the connecting screws located therein are easily accessible even in the use position of the load-accommodating means 10 with such a design. Each drilled hole 44 is substantially arranged at the same distance d from the edge of the load-accommodating means 10.

The cross section illustrated in FIG. 3b along the line III-III in FIG. 3a has the elastic damper element 42, which is connected to the rigid element 40 lying thereabove, on its lower side with respect to the alignment of the figure. The two openings 44 show in cross section that they are in the form of a cylindrical drilled hole 46 in the region of the damper element 42 and in the form of a conical depression 48 in the region of the rigid element 40. In addition, FIG. 3b also illustrates a spacer element 43 which is arranged on the support element 40. The spacer element has drilled holes 45 in which a screw shaft (not illustrated) can be accommodated. The design of the drilled hole 44 is illustrated in more detail in FIG. 3c in an enlarged cross section, the horizontally extending dashed line illustrating a screw head 50 which is countersunk in the drilled hole 44. As has already been mentioned, forming an opening or drilled hole 44 in the manner described prevents fixing forces from acting on the elastic damper element 42 and prevents its elastic deformation from being impeded or limited by screws located therein.

1. Industrial truck having at least one elongate load-accommodating means and a bearing structure supporting the load-accommodating means, the load-accommodating means being connected to the bearing structure and it being possible for said load-accommodating means to be pivoted about a pivot axis in relation to the bearing structure between a use position and a non-use position, the load-accommodating means being supported on the bearing structure in the use position, wherein a damping arrangement is provided on the load-accommodating means and/or on the bearing structure and has at least one elastic damper element.

2. Industrial truck according to claim 1, wherein the damping arrangement comprises at least one substantially rigid element, preferably a steel element, to which the damper element is fixedly connected and which can be arranged or is arranged on the bearing structure and/or the load-accommodating means.

3. Industrial truck according to claim 2, wherein the damping arrangement also comprises at least one spacer element which can be arranged or is arranged between the damper element and the base bearing said damper element, preferably between the rigid element and the base bearing the damping arrangement.

4. Industrial truck according to claim 1, wherein the damping arrangement has at least one fixing geometry, in particular a fixing cutout, preferably a fixing aperture, particularly preferably a drilled fixing hole.

5. Industrial truck according to claim 4, wherein the fixing geometry is a fixing cutout which comprises at least two successive cutout sections in the direction towards a base bearing the damping arrangement, of which the cutout section which is further away from the base has a greater clear width than that of the cutout section which is nearer to the base.

6. Industrial truck according to claim 4, wherein the distance between the fixing cutouts is greater than the width of the load-accommodating means.

7. Industrial truck according to claim 1, wherein the damping arrangement is fitted to the bearing structure.

8. Industrial truck according to claim 1, wherein the damper element is produced from plastic, preferably from an elastomer, such as rubber.

9. Industrial truck according to claim 1 wherein a distance between a standing area of the industrial truck and an underside, which faces the standing area, of the load-accommodating means increases at least in sections towards at least one longitudinal end of the load-accommodating means.

10. Industrial truck according to claim 9, wherein the distance between the standing area of the industrial truck and the underside of the load-accommodating means increases towards both longitudinal ends of the load-accommodating means.

11. Industrial truck having at least one elongate load-accommodating means and a bearing structure supporting the load-accommodating means, the load-accommodating means being connected to the bearing structure and it being possible for said load-accommodating means to be pivoted about a pivot axis in relation to the bearing structure between a use position and a non-use position, the load-accommodating means being supported on the bearing structure in the use position, wherein a distance between a standing area of the industrial truck and an underside, which faces the standing area, of the load-accommodating means increases at least in sections towards at least one longitudinal end of the load-accommodating means a damping arrangement is provided on the load-accommodating means and/or on the bearing structure and has at least one elastic damper element.

12. Industrial truck according to claim 11, wherein the distance between the standing area of the industrial truck and the underside of the load-accommodating means increases towards both longitudinal ends of the load-accommodating means.
